(19) United States
(12) Patent Application Publication
(10) Pub. No.: US 2010/0023588 A1
(43) Pub. Date: Jan. 28, 2010

(54) DOCUMENT DATA COMMUNICATION IN AN IMAGE FORMING SYSTEM

(75) Inventor: Tetsuji Yamaguchi, Osaka (JP)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Kyocera Mita Corporation, Osaka (JP)

(21) Appl. No.: 12/422,713

(22) Filed: Apr. 13, 2009

(30) Foreign Application Priority Data
Jul. 22, 2008 (JP) 2008-188228

(51) Int. Cl. G06F 15/16

(52) U.S. Cl. 709/206

(57) ABSTRACT

An image forming apparatus includes a first SOAP processing section and a first communication processing section. When the first communication processing section receives a data transmission request message from a client apparatus, the first SOAP processing section generates a response message described in XML. The response message includes document data specified by the data transmission request message. The first SOAP processing section instructs the first communication processing section to transmit the response message to the client apparatus. The client apparatus includes a second SOAP processing section and a second communication processing section. The second SOAP processing section instructs the second communication processing section to transmit the data transmission request that specifies the document data to the image forming apparatus. Upon receiving the response message from the second communication processing section, the second SOAP processing section extracts the document data specified by the data transmission message from the response message.

### INCORPORATION BY REFERENCE

This application is based upon and claims the benefit of priority from corresponding Japanese Patent Application No. 2008-188228, filed Jul. 22, 2008, the entire contents of which is incorporated herein by reference.

### BACKGROUND

1. Field of the Invention

The present invention relates to an image forming system and an image forming apparatus.

2. Description of the Related Art

Systems that transmit and receive command/response data between a client apparatus and a multi-function peripheral (MFP) in the form of simple object access protocol (SOAP) messages have been developed. In these systems, document data is stored in the MFP. By sending a command from the client apparatus to the MFP, a user can manipulate the document data.

In the above-described systems, when document data is downloaded from the MFP to the client apparatus, the client apparatus first sends to the MFP a request to download document data in the form of a SOAP message. Thereafter, response data is returned to the client apparatus from the MFP in the form of a SOAP message. The response data includes a uniform resource locator (URL) for the document data. The client apparatus downloads the document data specified by the URL using a hypertext transfer protocol (HTTP).

In this way, the document data is not transferred using the message protocol (e.g., SOAP) when the request and response data are transferred between the client apparatus and the multi-function peripheral. Instead, the document data is transferred using a lower-layer communication protocol (e.g., HTTP).

However, since a lower-layer communication protocol is used for transferring the document data, an application in the client apparatus needs to manage communication using the lower-layer protocol in addition to communication using the higher-layer protocol. Consequently, development of such an application becomes difficult.

### SUMMARY

The present invention relates to an image forming system and an image forming apparatus that facilitate development of applications in a client apparatus.

According to an embodiment of the present invention, an image forming system includes an image forming apparatus connected to a computer network and a client apparatus connected to the computer network.

The image forming apparatus includes a data storage device, a first communication processing section, and a first message processing section. The data storage device is configured to store document data. The first communication processing section is configured to receive a data transmission request message for requesting transmission of the document data and to transmit a corresponding response message. When the first communication processing section receives the data transmission request message from the client apparatus, the first message processing section generates the response message including the document data specified by the data transmission request message and instructs the first communication processing section to transmit the generated response message to the client apparatus.

The client apparatus includes a second communication processing section and a second message processing section. The second communication processing section is configured to transmit the data transmission request message and receive the response message. The second message processing section is configured to instruct the second communication processing section to transmit the data transmission request message that specifies the document data to the image forming apparatus. In addition, when the second communication processing section receives the response message from the image forming apparatus, the second message processing section extracts from the response message the document data specified by the data transmission request message.

Additional features and advantages are described herein, and will be apparent from the following Detailed Description and the figures.

### BRIEF DESCRIPTION OF THE FIGURES

In the accompanying drawings:

FIG. 1 is a schematic block diagram of an exemplary structure of an image forming system according to an embodiment of the present invention;

FIG. 2 illustrates download processing of document data performed by the image forming system shown in FIG. 1;

FIG. 3 illustrates an example of a download request message (a pre-request message);

FIG. 4 illustrates an example of a response message to the download request message shown in FIG. 3;

FIG. 5 illustrates an example of a data transmission request message;

FIG. 6 illustrates an example of a response message to the data transmission request message shown in FIG. 5; and

FIG. 7 illustrates a response message to the data transmission request message shown in FIG. 5.

### DETAILED DESCRIPTION

The following description, with reference to the drawings, sets forth embodiments according to the present invention.

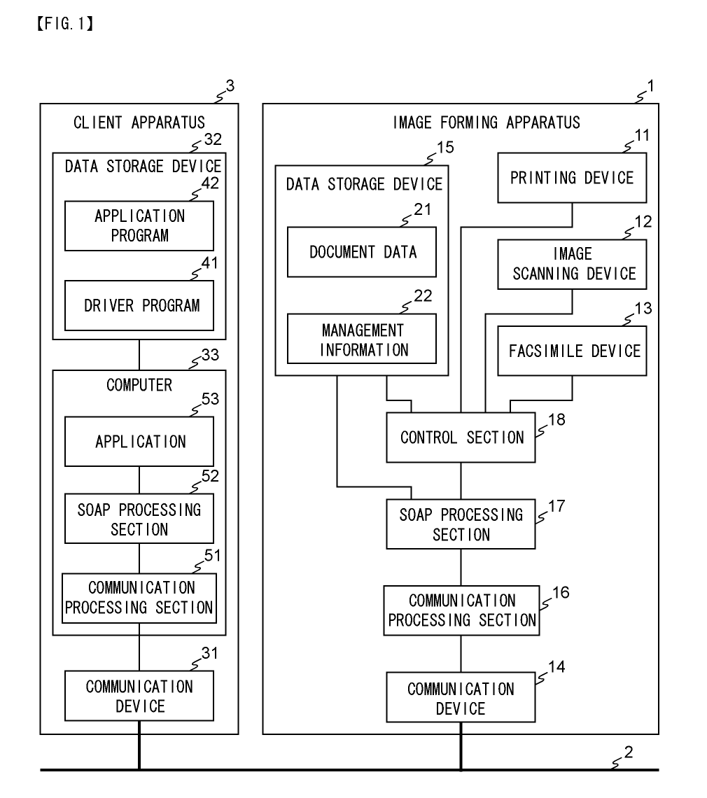

FIG. 1 is a schematic block diagram of an exemplary structure of an image forming system according to an embodiment of the present invention. In the image forming system illustrated in FIG. 1, an image forming apparatus 1 is connected to a computer network 2. A client apparatus 3 is connected to the computer network 2. The image forming apparatus 1 has a printing function, an image scanning function, and/or a facsimile transmission/reception function. Examples of the computer network 2 include a local area network (LAN) and a wide area network (WAN). An example of the client apparatus 3 is a personal computer.

The image forming apparatus 1 includes a printing device 11, an image scanning device 12, a facsimile device 13, a communication device 14, a data storage device 15, a communication processing section 16, a SOAP processing section 17, and a control section 18.

The printing device 11 is an internal device having a printing function for printing a document image based on document data. The image scanning device 12 is an internal device that optically scans a document image and generates image data of the document image. The facsimile device 13 is an internal device that generates a facsimile signal from document data to be transmitted and transmits the generated facsimile signal. The facsimile device 13 receives a facsimile signal and converts the facsimile signal into document data.

The communication device 14 is connected to the computer network 2. The communication device 14 communicates data with another apparatus (the client apparatus 3 in this example) connected to the computer network 2. An example of the communication device 14 is a network interface card (NIC).

The data storage device 15 stores document data 21 and management information 22. Examples of the data storage device 15 include a hard disk drive and a nonvolatile memory. Examples of the document data 21 include image data generated through image scanning performed by the image scanning device 12, image data generated from a facsimile signal received by the facsimile device 13, backup image data for backing up an image printed by the printing device 11, and backup image data for backing up an image transmitted by the facsimile device 13. In addition, areas for document boxes set for individual users or workgroups may be defined in the data storage device 15, and the document data 21 may be stored in one of the document boxes. The management information 22 includes internal status information and operation setting information pertaining to the image forming apparatus 1.

The communication processing section 16 (an example of a first communication processing section or a communication processing section) controls the communication device 14 so as to perform data communication via the computer network 2 using TCP/IP (transmission control protocol/Internet protocol). The communication processing section 16 has an HTTP client function and an HTTP server function.

The SOAP processing section 17 (an example of a first message processing section or a message processing section) controls the communication processing section 16 so as to send and receive a SOAP message. When the communication processing section 16 receives a data transmission request message from the client apparatus 3, the SOAP processing section 17 generates a response message written in an extensible markup language (XML) that includes document data specified by the data transmission request message. Thereafter, the SOAP processing section 17 instructs the communication processing section 16 to send the response message to the client apparatus 3.

According to the present embodiment, the data transmission request message and the response message are SOAP messages. The HTTP is bound as a lower-layer protocol than the SOAP. An endpoint URL is assigned to each of the image forming apparatus 1 and the client apparatus 3. The SOAP message is sent to the target endpoint using a POST command in the HTTP.

The control section 18 controls the internal devices, such as the printing device 11, the image scanning device 12, and the facsimile device 13, so as to execute a job requested by the client apparatus 3 or requested through an operation panel (not illustrated). The control section 18 controls the data storage device 15 so that the data storage device 15 stores the document data 21 generated by various jobs. The control section 18 monitors the states of the internal devices and updates the management information 22 in accordance with changes in those states.

The communication processing section 16, the SOAP processing section 17, and the control section 18 are realized by an internal computer (not illustrated) executing predetermined programs.

The client apparatus 3 includes a communication device 31, a data storage device 32, and a computer 33.

The communication device 31 is connected to the computer network 2. The communication device 31 is capable of communicating with another device (the image forming apparatus 1 in this example) connected to the computer network 2. An example of the communication device 31 is a NIC.

The data storage device 32 stores a driver program 41 and an application program 42. Examples of the data storage device 32 include a hard disk drive and a nonvolatile memory. It should be noted that the driver program 41 may be stored in a removable recording medium, such as a compact disk-read only memory (CD-ROM), and a drive unit that reads the driver program 41 from the recording medium may be used as the data storage device 32.

The computer 33 includes a central processing unit (CPU), a random access memory (RAM), and a read only memory (ROM), none of which are illustrated. The computer 33 loads a program into the RAM, for execution by the CPU. As such, the computer 33 implements various processing sections. The driver program 41 executed by the computer 33 implements a communication processing section 51 (an example of a second communication processing section) and a SOAP processing section 52 (an example of a second message processing section). The driver program 41 is an example of a computer program. The application program 42 executed by the computer 33 implements an application 53.

The communication processing section 51 controls the communication device 31 so as to perform data communication via the computer network 2 using a TCP/IP connection. The communication processing section 51 has an HTTP client function and an HTTP server function.

A SOAP processing section 52 controls the communication processing section 51 so as to send and receive SOAP messages. The SOAP processing section 52 instructs the communication processing section 51 to send a data transmission request message specifying desired document data to the image forming apparatus 1. When the communication processing section 51 receives a response message from the image forming apparatus 1, the SOAP processing section 52 extracts, from the response message, document data specified by the data transmission request message.

The application 53 serves as a processing section that acquires the document data 21 stored in the image forming apparatus 1.

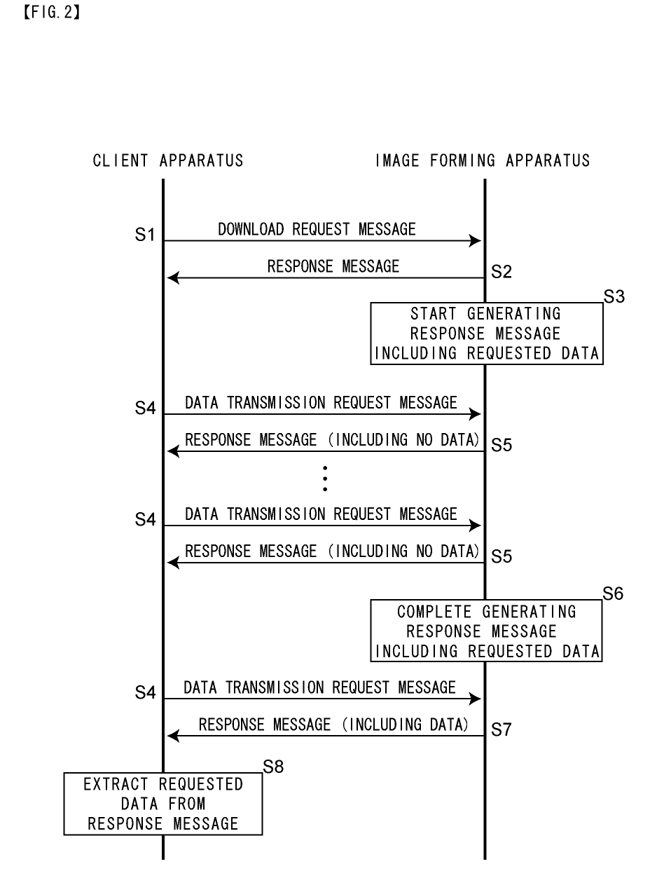

Exemplary operations performed by the various processing sections of the image forming system are described next. FIG. 2 illustrates download processing of document data performed by the image forming system shown in FIG. 1.

Upon detecting a user input operation performed on an input unit (e.g., a keyboard) (not illustrated) requesting that document data be downloaded, the application 53 in the client apparatus 3 instructs the SOAP processing section 52 to acquire document data indicated by the input operation.

The SOAP processing section 52 of the client apparatus 3 generates a download request message (that is, a pre-request message) and instructs the communication processing section 51 to send the generated message to the image forming apparatus 1 (step S1). The download request message is a SOAP message.

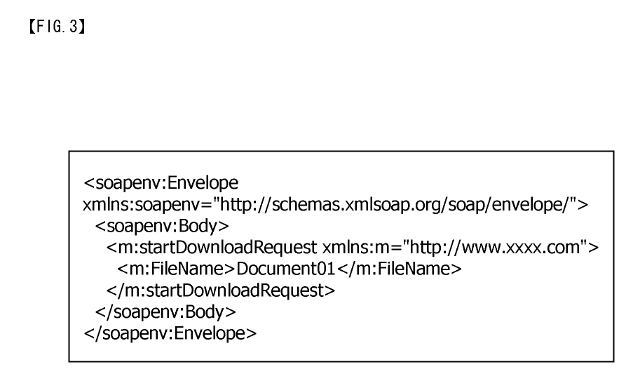

FIG. 3 illustrates an example of the download request message. As illustrated in FIG. 3, the download request message includes a startDownloadRequest element that represents a download request message and FileName element that specifies document data. The FileName element is a child element of the startDownloadRequest element.

The communication processing section 51 of the client apparatus 3 sends the message to the image forming apparatus 1 using an HTTP POST command. The message is transferred via the communication device 31, the computer network 2, and the communication device 14. The message is then received by the communication processing section 16 of the image forming apparatus 1.

Upon receiving the download request message using HTTP, the communication processing section 16 of the image forming apparatus 1 supplies the received download request message to the SOAP processing section 17. Upon receiving the download request message, the SOAP processing section 17 generates a response message. The SOAP processing section 17 then instructs the communication processing section 16 to send the response message to the client apparatus 3 (step S2).

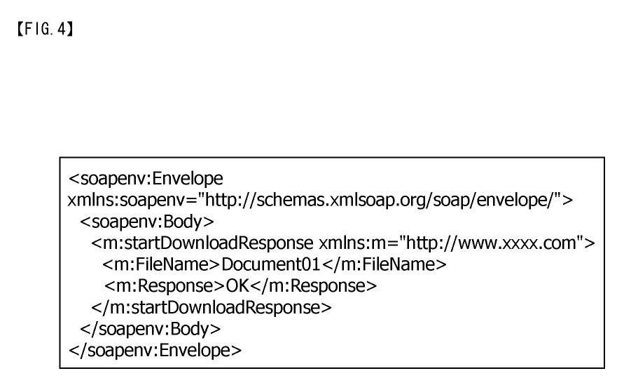

FIG. 4 illustrates an example of a response message to the download request message illustrated in FIG. 3. As illustrated in FIG. 4, the response message includes a startDownloadResponse element representing a response message to a download request message and a Response element including information regarding the response. The Response element is a child element of the startDownloadResponse element.

After sending the response message for the download request message, the SOAP processing section 17 of the image forming apparatus 1 starts generating a response message including the document data 21 specified by the download request message (step S3). This response message is a SOAP message. The SOAP processing section 17 reads the specified document data 21 from the data storage device 15 and generates the response message including the document data 21.

If binary data is included in the document data 21, the SOAP processing section 17 encodes the document data 21 into text data. Thereafter, the SOAP processing section 17 embeds the encoded document data 21 into the response message. For example, the document data 21 is encoded using a BASE64 method.

On the other hand, upon receiving the response message to the download request message, the communication processing section 51 of the client apparatus 3 supplies the response message to the SOAP processing section 52. When a predetermined time period has elapsed after the SOAP processing section 52 received the response message, the SOAP processing section 52 generates a data transmission request message at predetermined intervals and instructs the communication processing section 51 to send the generated message to the image forming apparatus 1 (step S4). The data transmission request message is a SOAP message.

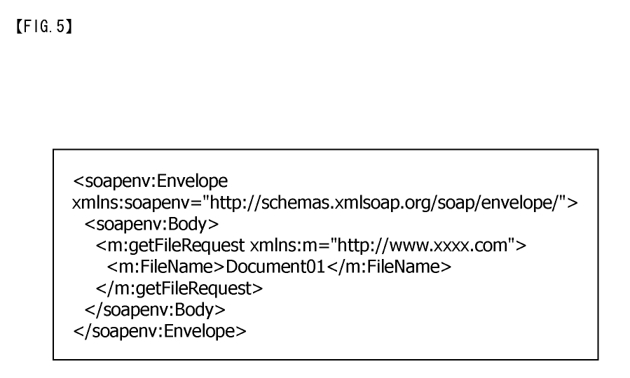

FIG. 5 illustrates an example of the data transmission request message. As illustrated in FIG. 5, the data transmission request message includes a getFileRequest element representing a data transmission request message and a FileName element indicating the document data 21. The FileName element is a child element of the getFileRequest element. This message is sent from the communication processing section 51 to the communication processing section 16 using HTTP. Upon receiving the data transmission request message, the communication processing section 16 of the image forming apparatus 1 supplies the data transmission request message to the SOAP processing section 17.

At that time, if generation of the response message started in step S3 has not been completed, the SOAP processing section 17 of the image forming apparatus 1 generates a response message indicating that the response message is being generated and instructs the communication processing section 16 to send the response message to the client apparatus 3 (step S5). The response message is a SOAP message. The response message includes no document data 21.

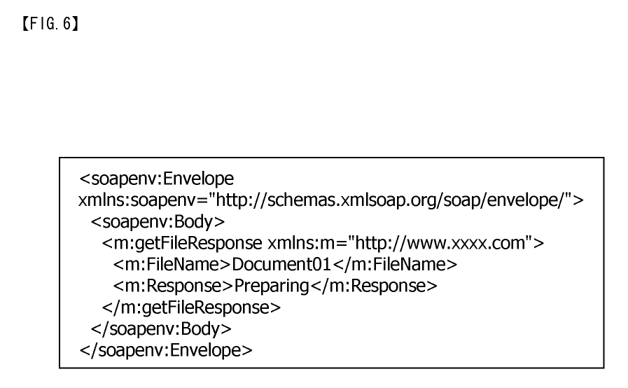

FIG. 6 illustrates an example of the response message to the data transmission request message shown in FIG. 5. As illustrated in FIG. 6, the response message includes a getFileResponse element representing a response message to the data transmission request message and a Response element indicating information about the response. The information about the response includes the character string “Preparing” indicating that the response message is being generated. The Response element is a child element of the getFileResponse element.

Upon receiving the response message, the communication processing section 51 of the client apparatus 3 supplies the response message to the SOAP processing section 52. When the SOAP processing section 52 receives the response message indicating that the response message is being generated, the SOAP processing section 52 continues to send the data transmission request message at the predetermined intervals.

Meanwhile, when the SOAP processing section 17 of the image forming apparatus 1 receives the data transmission request message after it has completed generating the response message including the document data 21 (step S6), it instructs the communication processing section 16 to send the generated response message to the client apparatus 3 (step S7).

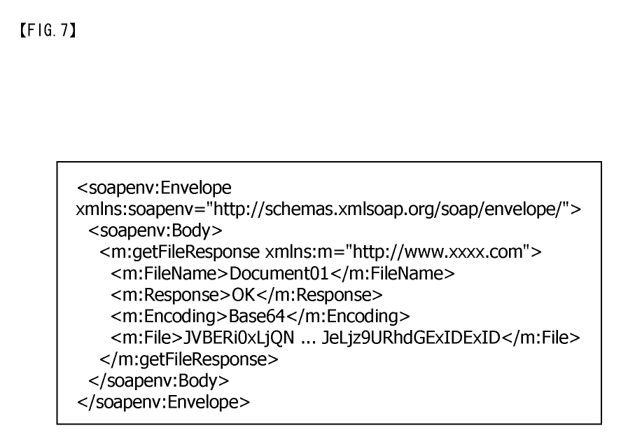

FIG. 7 illustrates the response message to the data transmission request message illustrated in FIG. 5. As illustrated in FIG. 7, the response message includes a Response element, which is a child element of a getFileResponse element. The Response element includes the character string “OK” indicating that generation of the response message has been completed. In addition, this response message includes an Encoding element indicating the encoding method used to encode the document data 21 into text data and a File element including the document data 21 in the form of text data. These elements are included in a body element of a SOAP envelope of the response message.

Upon receiving the response message, the communication processing section 51 of the client apparatus 3 supplies the response message to the SOAP processing section 52. The communication processing section 51 stops sending the data transmission request at the predetermined intervals. Upon receiving the response message including the document data 21, the SOAP processing section 52 extracts the document data 21 from the response message and supplies the document data 21 to the application 53 (step S8). At that time, the SOAP processing section 52 decodes the encoded document data 21 (encoded text data) and supplies the original document data 21 to the application 53.

According to the present embodiment, the SOAP processing section 52 of the client apparatus 3 instructs the communication processing section 51 to send the data transmission request message indicating the document data 21 to the image forming apparatus 1. When the communication processing section 16 of the image forming apparatus 1 receives the data transmission request message from the client apparatus 3, the SOAP processing section 17 of the image forming apparatus 1 generates the response message (described in XML) including the document data 21 specified by the data transmission request message. Thereafter, the SOAP processing section 17 instructs the communication processing section 16 to send the response message to the client apparatus 3. Once the communication processing section 51 receives a response message from the image forming apparatus 1, the SOAP processing section 52 extracts, from the response message, the document data 21 specified by the data transmission request message.

In this way, transmission and reception of the document data 21 can be performed using a message protocol including a data transmission request and a response to the data transmission request. Accordingly, this facilitates development of applications in the client apparatus 3.

When the document data 21 is directly transferred using HTTP, the URL of the document data 21 is accessible by external applications. However, according to the present embodiment, since a lower-layer communication protocol, such as HTTP, is not directly used for transferring the document data 21, the URL of the document data 21 can be protected from being accessed from the external applications. As a result, the security level can be increased.

Furthermore, according to the present embodiment, the SOAP processing section 52 of the client apparatus 3 instructs the communication processing section 51 to send a download request message to the image forming apparatus 1 so that the image forming apparatus 1 can start generating a response message. This is before a data transmission request message for requesting transmission of document data is sent. Subsequently, once the communication processing section 16 receives the download request message, the SOAP processing section 17 of the image forming apparatus 1 starts generating the response message including the document data specified by the download request message. This is before receiving the data transmission request message.

In this way, the client apparatus 3 can acquire the document data 21 in an asynchronous manner. Therefore, during a time period from when download of the document data 21 is requested to when the document data 21 is received, the client apparatus 3 can perform other processing. As a result, the processing speed of the client apparatus 3 can be increased.

Furthermore, according to the present embodiment, when the document data 21 is not text data, the SOAP processing section 17 of the image forming apparatus 1 encodes the document data 21 into text data using a predetermined encoding method and embeds the encoded document data into the response message. The SOAP processing section 52 extracts the encoded document data 21 and decodes the encoded document data 21 into the original document data 21 according to the predetermined encoding method. It should be noted that these encoding and decoding processes may be executed by processing sections other than the SOAP processing sections 17 and 52.

Accordingly, even when the document data 21 includes binary data, the document data 21 can be transmitted and received using the request and response message protocol.

The present invention includes various other embodiments. For example, other designs can be used in which the above-described components are each performed.

In the above-described embodiment, before a response message for a download request message is generated, it may be determined whether the document data 21 specified by the download request message is present and/or whether a user who logs in is authorized to download the document data 21. When the download request is approved, the information in the Response element illustrated in FIG. 4 may be set to the character string “OK”. However, when the download request is not approved, the information in the Response element illustrated in FIG. 4 may be set to a character string, such as “FileNonExist” and/or “NotAuthorized”, that indicates the reason for non-approval. In such a case, the SOAP processing section 52 of the client apparatus 3 may transmit the data transmission request message only when the information in the Response element is “OK”.

In addition, in the above-described embodiment, the document data 21 may be encrypted before being embedded into a response message. Thereafter, the response message may be transmitted from the image forming apparatus 1 to the client apparatus 3. In such a case, the client apparatus 3 extracts the document data 21 from the response message and decrypts the extracted document data 21. In addition, an encryption method used for the cipher communication may be specified in the download request message.

What is claimed is:

1. An image forming system comprising:
an image forming apparatus connected to a computer network; and
a client apparatus connected to the computer network;
wherein the image forming apparatus includes a data storage device configured to store document data, a first communication processing section configured to receive a data transmission request message for requesting transmission of the document data and to transmit a corresponding response message, and a first message processing section configured to, when the first communication processing section receives the data transmission request message from the client apparatus, generate the response message including the document data specified by the data transmission request message and instruct the first communication processing section to transmit the generated response message to the client apparatus, and
wherein the client apparatus includes a second communication processing section configured to transmit the data transmission request message and receive the response message and a second message processing section configured to instruct the second communication processing section to transmit the data transmission request message that specifies the document data to the image forming apparatus and, when the second communication processing section receives the response message from the image forming apparatus, extract the document data from the response message.

2. The image forming system according to claim 1, wherein the data transmission request message and the response message are Simple Object Access Protocol (SOAP) messages.

3. The image forming system according to claim 2, wherein the data transmission request message and the response message are transmitted and received using a POST command of Hypertext Transfer Protocol (HTTP).

4. The image forming system according to claim 1, wherein the data transmission request message and the response message are described in Extensible Markup Language (XML).

5. The image forming system according to claim 1, wherein the second message processing section instructs the second communication processing section to transmit a pre-request message for requesting download of the document data before transmitting the data transmission request message, and wherein, when the pre-request message is received by the first communication processing section, the first message processing section generates a response message for the pre-request message, and wherein, after instructing the first communication processing section to transmit the generated response message to the client apparatus, the first message processing section starts generating a response message that includes the document data specified by the pre-request message before receiving the data transmission request message.

6. The image forming system according to claim 5, wherein the pre-request message and the response message are SOAP messages.

7. The image forming system according to claim 6, wherein the pre-request message and the response message are transmitted and received using a POST command of HTTP.

8. The image forming system according to claim 5, wherein the pre-request message and the response message are described in XML.

9. The image forming system according to claim 1, wherein, if generation of the response message that includes the document data specified by the data transmission request message has not been completed when the data transmission request message is received, the first message processing section generates a response message indicating that the response message is being generated and instructs the first communication processing section to transmit the generated response message to the client apparatus.

10. The image forming system according to claim 9, wherein, when the second communication processing section receives the response message indicating that the response message is being generated, the second message processing section instructs the second communication processing section to retransmit the data transmission request message specifying the document data to the image forming apparatus.

11. The image forming system according to claim 1, wherein, when the document data is not text data, the first message processing section encodes the document data into text data using a predetermined encoding method and embeds the encoded document data into the response message, and wherein the second message processing section decodes the extracted encoded document data into the original document data using the predetermined encoding method.

12. The image forming system according to claim 11, wherein the response message is a SOAP message, and wherein the document data encoded into text data is included in a body element of a SOAP envelope in the response message.

13. The image forming system according to claim 12, wherein the SOAP envelope in the response message includes an element indicating the predetermined encoding method.

14. The image forming system according to claim 13, wherein the predetermined encoding method is a BASE64 method.

15. An image forming apparatus for communicating with a client apparatus via a computer network, comprising:
a data storage device configured to store document data;
a communication processing section configured to receive a data transmission request message and to transmit a corresponding response message; and
a message processing section configured to, when the communication processing section receives from the client apparatus the data transmission request message specifying document data to be transmitted, generate the response message including the document data specified by the data transmission request message and instruct the communication processing section to transmit the generated response message to the client apparatus.

16. The image forming apparatus according to claim 15, wherein the data transmission request message and the response message are SOAP messages.

17. The image forming system according to claim 16, wherein the data transmission request message and the response message are transmitted and received using a POST command of HTTP.

18. The image forming system according to claim 15, wherein the data transmission request message and the response message are described in XML.

19. A method for communicating document data from an image forming apparatus to a client apparatus, the method comprising:
receiving at a communication processing section of the image forming apparatus a data transmission request message from the client apparatus, wherein the data transmission request message specifies document data to be transmitted to the client apparatus, and wherein the document data is stored in a data storage device associated with the image forming apparatus;
generating at a message processing section of the image forming device a response message that includes the document data specified by the data transmission request message, wherein the message processing section instructs the communication processing section to transmit the generated response message to the client apparatus; and
transmitting at the communication processing section the generated response message to the client apparatus.

20. The method of claim 19, wherein the data transmission request message and the response message are SOAP messages that are transmitted and received using a POST command of HTTP.
